(19) United States
(12) Patent Application Publication
(10) Pub. No.: US 2017/0228211 A1
(43) Pub. Date: Aug. 10, 2017

(54) RESTAURANT AUDIO CONTROL SYSTEM

(71) Applicant: SAMI FAHID DAOUD, CINCINNATI, OH (US)

(72) Inventor: SAMI FAHID DAOUD, CINCINNATI, OH (US)

(21) Appl. No.: 15/016,135

(22) Filed: Feb. 4, 2016

(51) Int. Cl. G06F 3/16; G06T 11/60; G06Q 30/06; G06T 3/40; H04W 4/04; G06Q 50/12; G06F 3/0482; H04N 1/00

(52) U.S. Cl. CPC G06F 3/162; G06F 3/165; G06F 3/0482; G06T 11/60; H04N 1/00244; G06T 3/4038; H04N 1/00307; H04W 4/043; G06Q 50/12; G06Q 30/0641; H04N 2201/0084

(57) ABSTRACT

A method of providing a jukebox comprising steps of a user checking-in at a given location on a smartphone, the user adjusting the independent volume control in the user's vicinity from the smartphone, wherein the smartphone is in communication with a switch electrically connected with speakers in the user's vicinity, the user navigating to the jukebox selection screen wherein a list of available music is displayed, the user choosing one or more songs, the chosen one or more songs are added to the server playback queue, and the next song from the server playback queue is played when the current song finishes. In an embodiment, a further step has a music list playing randomly from music stored on a server while the server playback queue is empty. In a further embodiment, the location is known by a GPS subunit, and each given location has a unique server playback queue.

### BACKGROUND OF THE INVENTION

1. Field of Invention

The present invention relates to the field of systems for controlling audio in public spaces.

2. Description of Related Art

Jukeboxes have been used in restaurants and public spaces for a number of years. Typically, a customer inserts money and selects one or more songs from the jukebox, which then enter into a queue for playing. In a distributed jukebox, control is exerted over the playlist at each table, or in a number of locations throughout the facility. Jukeboxes give customers some control over the music, making them part of the environment and giving them a more satisfying customer experience.

The volume of the jukebox is set to a certain pre-determined level throughout the facility, and while customers may control the song queue, they typically do not have control over volume, which is normally centralized and accessible only to staff. More and more, public spaces are used for meetings and conversations, wherein it is desirable for the customer to control the volume so he or she is able to hear the conversation with his or her associates. However, some customers may want to hear the jukebox at full ambient volume while others having a conversation want the local area volume to be reduced, therefore it is desirable to be able to selectively reduce the volume in the area in which a customer is sitting.

Therefore there is a need in the art for a restaurant system for controlling the jukebox and volume while the customer is seated in the restaurant.

### SUMMARY OF THE INVENTION

A method of providing a jukebox has the steps of a user checking in at a given location on a smartphone, the user adjusting the independent volume control in the user's vicinity from the smartphone, wherein the smartphone is in communication with a switch electrically connected with one or more speakers in the user's vicinity, the user navigating to the jukebox selection screen wherein a list of available music is displayed, the user choosing one or more songs, the chosen one or more songs are added to the server playback queue, and the next song from the server playback queue is played when the current song finishes. In an embodiment, a further step has a music list playing randomly from music stored on a server while the server playback queue is empty. In a further embodiment, the location may be known by a GPS subunit, and each given location has a unique server playback queue.

In one embodiment, The method of providing a jukebox has the steps of the user taking one or more photos with a smartphone, the user communicating the photos to a server through an app, the server storing and organizing the photos, and creating collages for display, the server communicating the collage to one or more digital frames within the given location, and the one or more digital frames displaying the collage.

The method may also have the step of the user adding captions to the one or more photos, and/or the step of the user sharing the one or more photos through sharing facilities. The photos for a given location may be shown only in that location, and the location is known by a GPS subunit. Each given location may also have a unique server playback queue. News of the location may be provided to the user through the smartphone.

The method may have the further step of ordering food through the smartphone app based on a given location, and the smartphone may show the user a virtual menu and the user selecting one or more food items with a shopping basket. The smartphone may also show the user a coupon that is unlocked using an unlock item. The server may compile usage statistics indicating song and photo usage as well as user engagement.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart of one embodiment of the photo portion of the system, according to an embodiment of the present invention;

FIG. 2 is a flowchart of the photo portion the system, according to an embodiment of the present invention; and

FIG. 3 is a flowchart of the music jukebox portion of the system, according to an embodiment of the present invention.

### DETAILED DESCRIPTION OF PREFERRED EMBODIMENTS

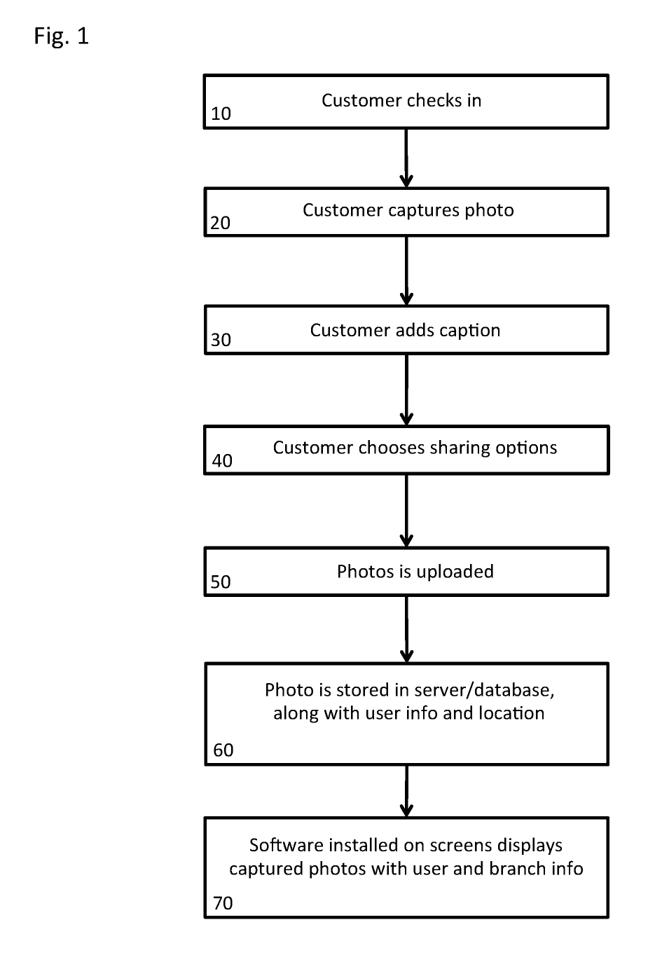

Preferred embodiments of the present invention and their advantages may be understood by referring to FIGS. 1-3, wherein like reference numerals refer to like elements.

The system may consist generally of a server and a plurality of mobile devices, which are connected by networks. The plurality of mobile devices communicate with the server through software which runs on the devices and provides input such as photos, song selection, orders, and location information to the server. In addition, there are a plurality of screens, such as digital frames or televisions, that are connected to the server, by means of dongles or internal networking capability. The server operates a photo system, which queries and displays photos of other patrons from patron's phones on the screens. The server also operates a music system, which provides a song list and an interactive menu, and handles playback requests. The server regulates other output to the devices and other peripherals such as screens positioned throughout an establishment and related establishments, and through the speakers in the establishment and related establishments, each of which has a server for controlling the audio and video output of the establishment.

With reference to FIG. 1, the user flow chart is shown. Once commencing use of the software app, at step 10 a user “checks in” to a given location, either by establishment, or by establishment and location within the establishment. Location within the establishment may be determined by table location or by another pre-determined segmentation procedure, wherein sections are allocated and customers are designated within sections. In an embodiment, the customer who checks-in most frequently to a location is rewarded with a designation such as “man/lady of the house”. This designation and/or the customer location may be shared using social media, and there may be a ranking, based on number of check-ins, wherein the customer may compare position with others on a leaderboard. In one embodiment, the GPS location of the device is transmitted by the app to the server, and when the location coincides generally with an establishment, it is determined that the customer is present at the establishment.

The customer may also order a table remotely through the check-in feature, for example when the customer is close to the establishment or indicates that he or she is going to the establishment, a table may be reserved. The customer may also see the location of nearby related establishments on a map or navigation program, to enable the customer to find the location easily.

In step 20, a customer may capture photos, in that the devices are used to take photos of the customers, environment, and may constitute “selfies”. In step 30, the customer optionally adds a caption to the photo, either to describe or provide context on the subject matter of the photo, or imply a statement that the subject of the photo is making.

In step 40, the customer specifies sharing options, and logs in through a social network or other sharing means to facilitate sharing. In step 50 the images are uploaded or communicated to the server through the app software on the device. In step 60 the server stores and organizes the photos, and creates collages and queues for the screens to display. In addition, the user information and location are also stored with the photos. In step 70 photos from a given establishment may be shown only within the establishment, or across a number of related establishments to show what people in other countries or localities are doing, wherein the location is known by the associated GPS location and the actual location of the establishment may be added to the photo. Photos may also be reproduced on a website or shown through the app.

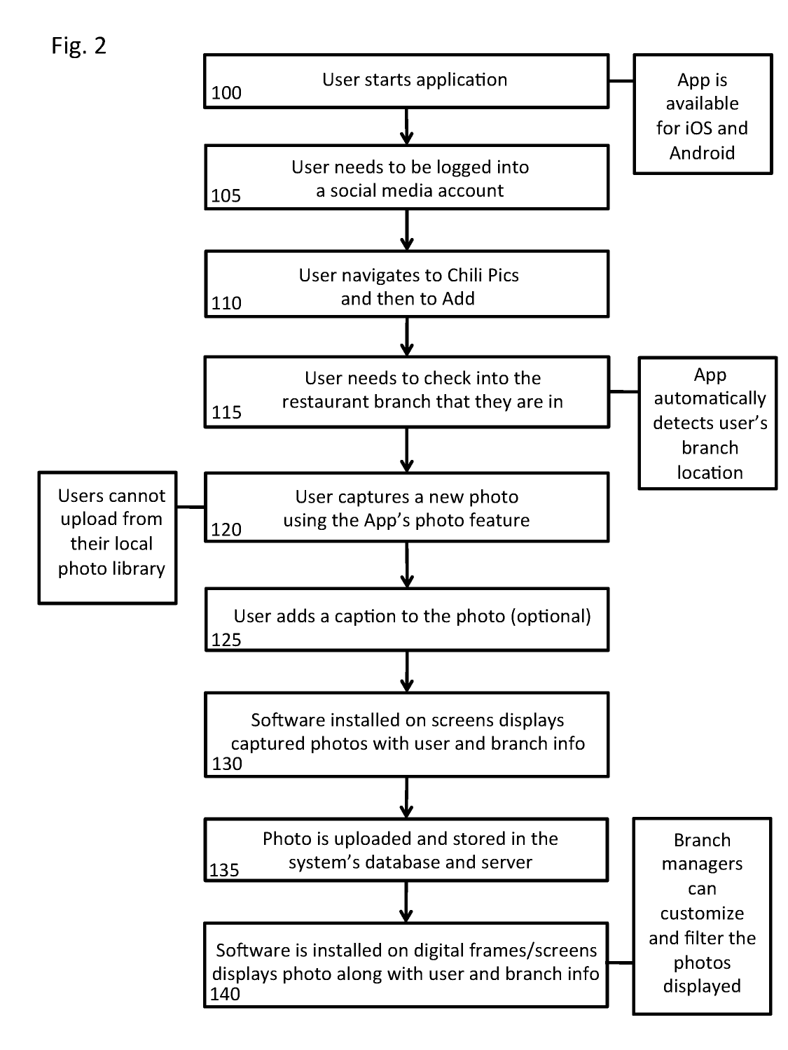

With reference to FIG. 2, in another embodiment of the system, in step 100 once downloaded the user starts the app, and in step 105 logs in using a social network account. Using a social network account for the user's log-in limits the number of fake accounts and reduces the chance of explicit content being uploaded. In step 110 the user navigates to “Photos” and clicks “add”. In step 115 the user may check-in to the branch of the restaurant once they are inside. In an embodiment, the system automatically detects the branch based on the location of the user. In step 120 the user captures a new photo using the photo feature, but prevents the user from uploading from their local photo library to ensure that the photos are from the branches. In step 125 the user optionally adds a caption to the photo, and in step 130 the user optionally chooses photo-sharing options (social networks, email, text-message or Twitter, etc.) In step 135, the photo is uploaded and stored in the system's database and server. In step 140, software installed on the digital frames or screens displays photos along with user and branch information. In an embodiment, branch managers can customize and filter the photos displayed, based on filtering date, number, branch and sorting.

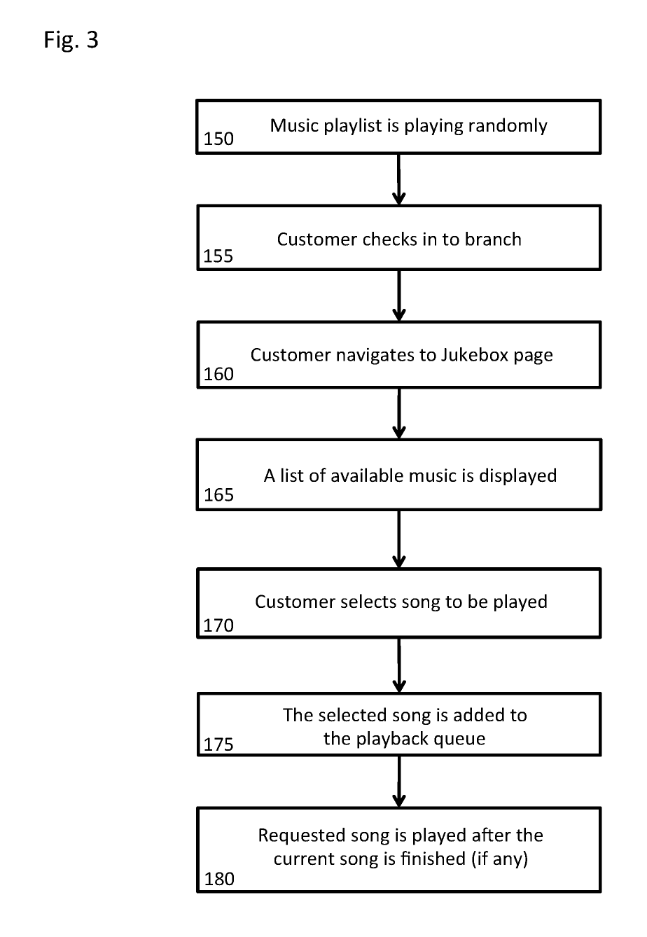

With reference to FIG. 3, a flowchart showing the jukebox feature is displayed. In step 150, the music list is playing randomly, based on music that is stored within the server. In step 155, the customer checks into the branch either manually or automatically via GPS location. In step 160, the customer navigates to the Jukebox page, and, in an embodiment, may adjust the volume control of his or her section or overall branch. In step 165, a list of available music is displayed, and in step 170, the customer selects a song to be played. In step 175, the selected song is added to the playback queue on the server. In step 180, the requested song is played after the current one finishes. Once the requested songs have been played, the music player reverts to a random play mode as in step 150.

A central server hosts a jukebox for a given establishment location, including the encoded songs data as well as a queue for songs. Each device may reproduce the catalog of songs and provide a list for a user to select songs from the stored songs, or the songs may be streamed from a network. Selected songs enter a queue to be played within the establishment as a jukebox feature. The order may be determined as a FIFO queue or by other methods wherein the customers may advance the order of their song based on other criteria. The song is played in the establishment where the customer is checked-in, or may be shared across establishments.

Each location, such as a section or table, within the establishment has an independent volume control, which is available nearby the table. Each table may have one or more speakers, or there may be one or more speakers associated with tables or nearby, or divided by sections in the branch or establishment. It may be a switch on the table or on the wall, which is adjustable to reduce or increase the volume in a given location, not throughout the establishment on the whole. The switch is networked to the music server and provides a volume signal to the server, which adjusts the volume of the location only or the section within the location, without necessity of adjusting the volume of the establishment on the whole. In another embodiment, the switch is attached directly to the speakers and manipulated by hand by customers, in order to adjust volume.

The app also provides a news feature along with the photo-sharing, wherein news regarding the establishment or chain of establishments, or marketing material and/or promotions may be made available to customers.

Food may be ordered through the app, which provides a virtual menu and stored payment means, such as a credit card. Once menu items are selected they are added to a shopping basket, which allows the customer to check out with one or more food items for delivery within the restaurant, wherein the table location is noted, or take-out delivery to a residence or business address.

After a certain number of visits to an establishment or to a restaurant chain, the user receives an automatically-generated coupon which he or she can unlock using an unlock icon. The coupon may provide a discount to the establishment or to the chain generally. In one embodiment, after 4 visits a coupon is unlocked for the 5^{th} check-in.

The app may compile usage statistics and analyze to determine the user behavior and spending patterns, the location of users and feedback regarding requests and/or complaints. The analysis may also help determine bugs and crash frequency, and fixes.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method of providing a jukebox, comprising the steps of:
a. a user checking in at a given location on a smartphone;
b. the user adjusting the independent volume control in the user's vicinity from the smartphone, wherein the smartphone is in communication with a switch electrically connected with one or more speakers in the user's vicinity;
c. the user navigating to the jukebox selection screen wherein a list of available music is displayed;
d. the user choosing one or more songs;
e. the chosen one or more songs are added to the server playback queue; and
f. the next song from the server playback queue is played when the current song finishes.

2. The method of providing a jukebox, further comprising the steps of:
a. the user taking one or more photos with a smartphone;
b. the user communicating the photos to a server through an app;
c. the server storing and organizing the photos, and creating collages for display;
d. the server communicating the collage to one or more digital frames within the given location; and
e. the one or more digital frames displaying the collage.

3. The method of providing a jukebox of claim 1, further comprising the step of a music list playing randomly from music stored on a server while the server playback queue is empty.

4. The method of providing a jukebox of claim 2, further comprising the step of the user adding captions to the one or more photos.

5. The method of providing a jukebox of claim 2, further comprising the step of the user sharing the one or more photos through sharing facilities.

6. The method of providing a jukebox of claim 2, wherein the photos for a given location are shown only in that location.

7. The method of providing a jukebox of claim 1, wherein the location is known by a GPS subunit.

8. The method of claim 1, wherein each given location has a unique server playback queue.

9. The method of claim 1, wherein news of the location is provided to the user through the smartphone.

10. The method of claim 1, further comprising the step of ordering food through the smartphone app based on a given location.

11. The method of claim 10, further comprising the smartphone showing the user a virtual menu and the user selecting one or more food items with a shopping basket.

12. The method of claim 1, further comprising the smartphone showing the user a coupon that is unlocked using an unlock item.

13. The method of claim 1, further comprising the server compiling usage statistics indicating song and photo usage as well as user engagement.
